(19) United States
(12) Patent Application Publication
(10) Pub. No.: US 2002/0171524 A1
(43) Pub. Date: Nov. 21, 2002

(54) Ignition coil

(76) Inventor: Mu-Shui Tsai, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/855,599

(22) Filed: May 16, 2001

(51) Int. Cl. H01F 27/02

(52) U.S. Cl. 336/96

(57) ABSTRACT

An ignition coil provides a socket between an outer iron core and an excitation core, and to place a non-magnetic metal therein. A U-shaped non-magnetic metal is placed in the socket with the two inner sides wrapping two permanent magnets. The outer iron core contacts the excitation coil in a deeper of depth, so that it produces a best excitation effect and collects more magnetic power that increases the magnetization of the ignition coil, it not only minimizes the size but also increases the magnetization.

### BACKGROUND OF THE INVENTION

1. Field of the Invention

This invention relates to an ignition coil, and more particularly to have a socket in between an outer iron core and an excitation core with a non-magnetic metal attached therein, and a pair of permanent magnets attached to the respect sides of the non-magnetic metal.

2. Description of the Related Prior Art

All vehicles require a high voltage supply to start the engine, the battery can provide only a low voltage, that is why an ignition coil is adapted. There are many related patents relating to ignition coils, such as German Patent No.7924989 U.S. Pat. Nos. 4,546,753 and 5,335,642, Japanese Patents #237705 and #6-84666 and Taiwanese Patent No. 12695. Many of which are applied a permanent magnet in an ignition coil. Recently, NdFeb permanent magnet has been widely adapted, which is more efficient and less expensive, compared with the Sm. Co. of the previous material.

In the U.S. Pat. No. 5,335,642, and Taiwan Patent #126695, a permanent magnet is placed above an excitation core, horizontally, to increase the magnetization effect. The Taiwanese patent discloses that the permanent magnet keeps a gap with an outer core, and an excitation core is wrapped by a primary coil and a secondary coil to form an enclosed magnetic circuit. The excitation core is magnetized by the permanent magnet to a negative direction, thus it reaches to a maximized density. This negative is in a reversed direction with respect to the energy generated by the primary coil. When igniting the vehicle, the excitation coil through the primary coil produces a magnetization equivalent to the permanent magnet, which magnetizes the coil to reach a positive maximized density. Under this circumstance, when the primary coil is interrupted during ignition, the secondary coil will continue the process, which is more efficient than a traditional ignition system. The tradition ignition system uses only a primary coil without a permanent magnet, the weight and size are less than the traditional coil.

Further, when manufacturing the permanent magnet, the excitation coil and the outer coil, there are differential which produces gaps between the permanent magnet, the excitation coil and the outer iron core after assembling, and gaps will also be occurred between the excitation coil and the outer iron core. In order to receive a better electromagnet effect of the ignition coil, the gaps must be eliminated. The prior art has increased the width of the adjacent areas of the permanent magnet and the excitation coil to produce a larger contact area, which minimizes the gaps from the upper surface and the lower surface of connecting areas and increases the magnetization of the permanent magnet. This design is to form a T-shaped at one end of the excitation coil to match and engage with the permanent magnet, in order to minimize the connecting gap, however this design still has some shortcomings listed below:

1. Although the connecting areas are expanded to increase the magnetization effect, the permanent magnet is located on top of and in parallel with the excitation coil, which provides a limited magnetization effect.

2. The permanent magnet may deviate for its position due to a lack of securing device, which causes decrease of magnet effect.

3. In the prior ignition cores, the outer iron core, the excitation coil, the permanent magnet, the primary coil and the secondary coil were wrapped by resin, as shown in FIG. 4. The fore-said gaps are filled up with resin to form an isolator A. However, since the outer iron core, the excitation coil, the permanent magnet are made of metal material and resin is a non-metal material, that has a different expansion factor, thus, when the temperature arise, the resin may be deviated.

In order to correct the problems and many other shortcomings, the inventor has invented the present invention, which has minimized the gap and increased the capability.

### SUMMARY OF THE INVENTION

It is the primary object of the present invention to provide an ignition coil, which has a socket to accommodate the permanent magnet and the excitation coil securely.

It is another object of the present invention to provide an ignition coil, which includes two permanent magnets having maintained a large contact area with an excitation core which increases magnetization effect.

It is a further object of the present invention to provide an ignition coil, which has minimized the expansion factor to the most.

It is still a further object of the present invention to provide an ignition coil, which is designed to fill in resin as to secure the permanent magnet for a better effect.

### BRIEF DESCRIPTION OF THE DRAWINGS

FIG. 1 is an exploded view of the present invention;

FIG. 2 is a side elevation view of a first embodiment of the present invention, having partially sectioned;

FIG. 3 is another side view of a second embodiment of the present invention, having partially sectioned;

FIG. 4 is a side view of a prior art; and

FIG. 4A is a partially enlarged view of FIG. 4.

### DETAILED DESCRIPTION OF THE PREFERRED EMBODIMENTS

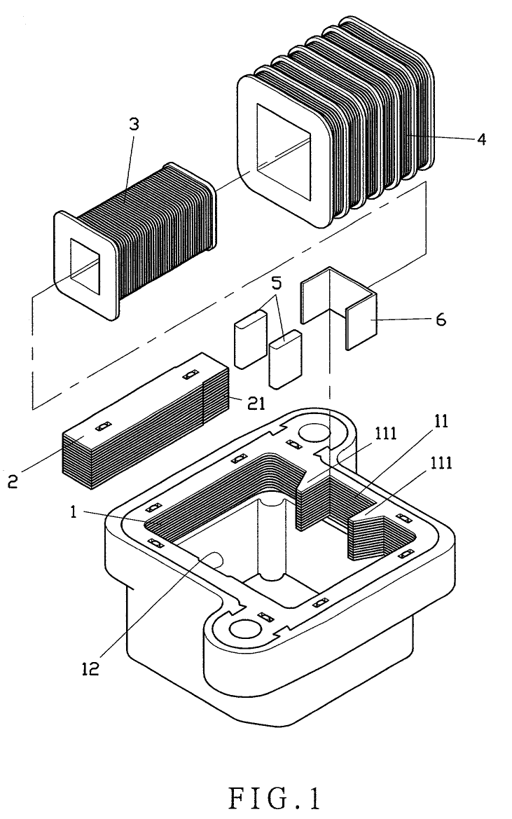

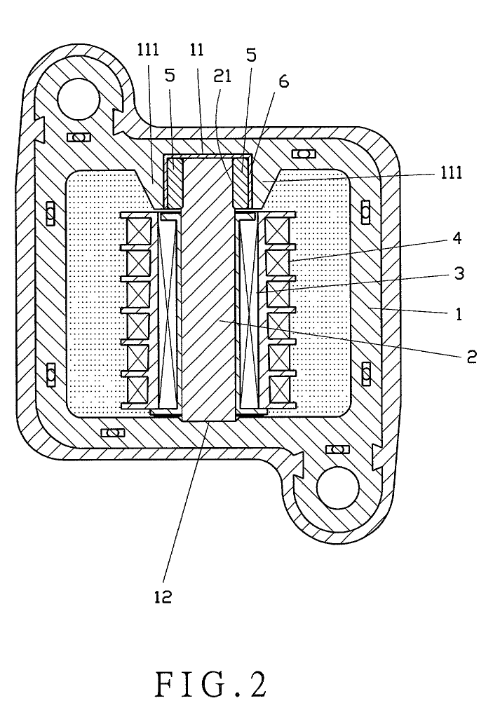

The ignition coil of the present invention, as shown in FIGS. 1 and 2, comprises an outer iron core 1, an excitation coil 2, a primary coil 3, a secondary coil 4 and a pair of permanent magnets 5. The primary coil 3 and the secondary coil 4 are sleeved onto the excitation coil 2, and then placed in the center of the outer iron core 1.

The outer iron core 1 extends a pair of projections 111 from one inner wall and to form a socket 11 in a proper depth, so that the excitation coil 2 can be placed in the outer iron core 1 with a narrow end seating in the socket 11. A pair of permanent magnets 5 is attached to recesses 21 of the excitation coil 2. Whereas the other end of the excitation coil 2 engages with a recess 12 at the other end of the outer iron core 1. A U-shaped non-magnetic metal 6 is also placed in the socket 11 with the two inner sides wrapping the two permanent magnets 5, while the outsides of the non-magnetic metal 6 are engaging with the inner wall of the socket 11. This insertion reduces a gap formed thereat.

The permanent magnets 5 are placed on two sides of one end of the excitation coil 2, and the outer iron core 1 contacts the excitation coil 2 with the sockets. This design provides a secure assembly and increases contact points of the excitation coil 2 with the permanent magnets 5 in a deeper of depth, thus, the magnetization effect is better.

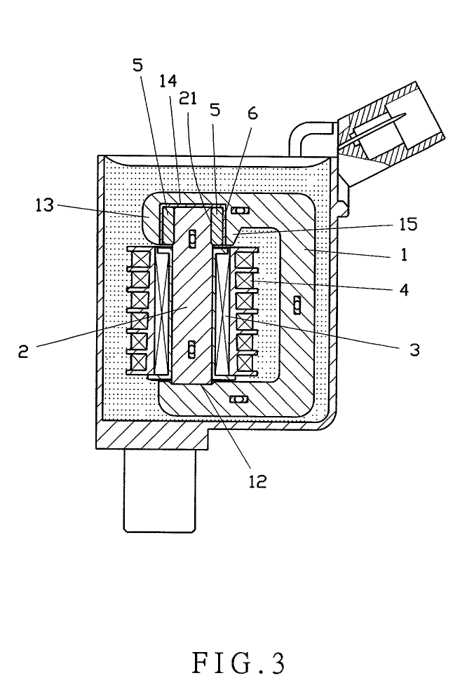

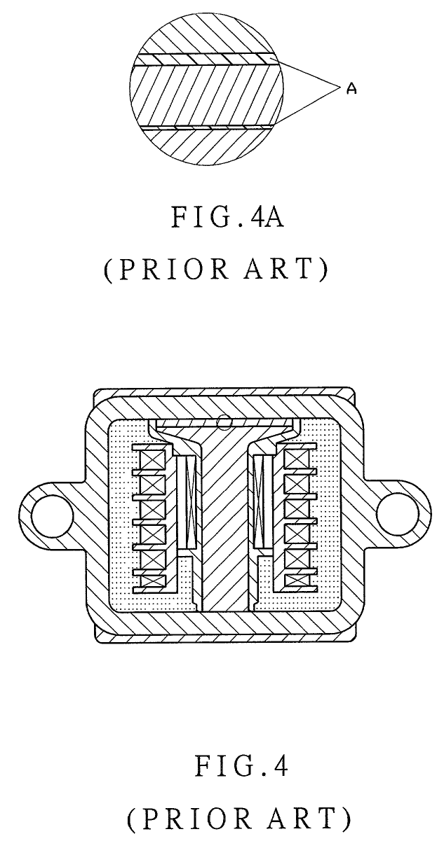

FIG. 3 has shown a U-shaped iron core to accommodate the excitation coil 2 along with the primary coil 3 and the secondary coil 4 at an open end. Wherein, one side of the outer iron core 1 for the excitation coil 2 to be placed is formed with a wider end 13. The wider end 13 provides a socket 14 from the inner wall and extends a projection 15 at the adjacent side of the socket 14. The socket 14 is to receive the narrow end of the excitation coil 2. A pair of permanent magnets 5 is attached to recesses 21 of the excitation coil 2. Whereas the other end of the excitation coil 2 engages with a recess 12 at the other end of the outer iron core 1. A non-magnetic metal 6 is placed in the socket 11 with the two inner sides wrapping the two permanent magnets 5, while the outsides of the non-magnetic metal 6 are engaging with the inner wall of the socket 11. Thus, the U-shaped iron core increases the magnetization capability.

The present invention compared to the prior art has the following advantages:

1. The socket is in a proper depth, which provides a more secure way to install the permanent magnets and the excitation core.

2. The two permanent magnets provide a larger contact area with the excitation core, which increases magnetization effect.

3. The permanent magnets are secured vertically and attached to respective sides of one end of the excitation core, which has a larger contact in depth, thus, it provides a better magnetization effect to the excitation core.

4. The non-magnetic metal filled in the gaps between one end of the excitation core has a similar expansion factor to the permanent magnets and the excitation core. When the temperature of the ignition core arises, the deviated effect is limited to the least.

5. To assemble, the deviated space between the non-magnetic metal and permanent magnets is limited to the least, which provides a better installed effect. When filling resin, the permanent magnets is not easy to deviate, that gets better ignition core products.

I claim:

1. An ignition coil comprising an outer iron core, an excitation coil, a primary coil, a secondary coil, and a pair of permanent magnets to form a close magnetic circuit, wherein,
said outer iron core comprising a socket for a narrow end of said excitation coil to seat therein, having a pair of permanent magnets to be attached to respective sides of a narrow end of the excitation coil, a U-shaped non-magnetic metal being placed in the socket with the two inner sides wrapping the permanent magnets.

2. The ignition coil, as recited in claim 1, wherein said socket has as a pair of projections extending from respective sides or a single projection extending from one side.
